(19) United States
(12) Patent Application Publication
(10) Pub. No.: US 2023/0044288 A1
(43) Pub. Date: Feb. 9, 2023

(54) COMPUTER IMPLEMENTED SYSTEM AND METHOD OF ENRICHMENT OF DATA FOR DIGITAL PRODUCT DEFINITION IN A HETEROGENOUS ENVIRONMENT

(71) Applicant: INFOSYS LIMITED, Bangalore (IN)

(72) Inventor: Kannan Gopalakrishnan, Chennai (IN)

(21) Appl. No.: 17/554,080

(22) Filed: Dec. 17, 2021

(30) Foreign Application Priority Data
Aug. 9, 2021 (IN) 202141035984

(51) Int. Cl. G06F 16/25; G06F 16/2458; G06F 16/906; G06F 16/215

(52) U.S. Cl. CPC G06F 16/258; G06F 16/2471; G06F 16/906; G06F 16/215

(57) ABSTRACT

A method of enrichment of data for digital product definition in a heterogeneous environment includes converting an input unstructured data into structured data by a mining engine. The mining engine also performs the assignment of a priority to the converted structured data and merges it with an input structured data. A matching engine is used for categorizing the merged converted structured data based on a predefined set of rules. A profiling engine validates the merged converted structured data against the digital product definition and the steps of converting, categorizing and validating are iterated till an optimized data for digital product definition is acheived.

This application claims the benefit of Indian Patent Application Serial No. 202141035984 filed Sep. 8, 2021, which is hereby incorporated by reference in its entirety.

### FIELD

The present disclosure relates to method and system of enrichment of data for digital product definition in a heterogeneous environment.

### BACKGROUND

In all digital transformations, massive data digitization in short time is always a challenge and directly impacts the cost, quality, and schedule of a project. When Scattered multiple external sources provide the data, the single source of truth is lost and leads to conflicting information and not useful for any digital use. Aligning to consistent data model with single source of truth requires robust method to map and validate the data with adequate iteration with traceability and accountability.

CPG and F&B industries requires specification or master recipe consolidation or structured data form in order to use as digital data in various applications such as PLM or MES. In today's world, many applications still have their existing specifications such as ingredients, formulation, packaging material are maintained so far as an unstructured document either in the form of document or in multiple siloed legacy applications. These documents and siloed data from multiple sources in different formats require to be prepared with huge data cleansing, data enrichment ensuring data alignment and data validation. In the industry no specific software provides the facility to collaboratively build the data and load into PLM without data challenges. The proposed invention provides facility to compose the multi-source/heterogeneous data by eliminating conflicts and validate for the future business rules. Data mining leverages existing AI/ML mechanism to reduce the human effort to identify the data from unstructured data. Data matching uses the AI/ML mechanism to fit the right data when the data is flowing from multiple sources

### SUMMARY

The method of enrichment of data for digital product definition in a heterogeneous environment; comprising of converting an input unstructured data into structured data by a mining engine. The mining engine also performs the assignment of a priority to the converted structured data and merges it with an input structured data. A matching engine is used for categorizing the merged converted structured data based on a predefined set of rules. A profiling engine validates the merged converted structured data against the digital product definition and the steps of converting, categorizing and validating are iterated till we achieve an optimized data for digital product definition.

The structured data and the unstructured data are received through a user interface and an automated data ingestion module.

The priority is assigned based on predefined target data structure attributes, contextual attribute tokenization and the machine learning dependent attribute value selection.

The categorization of the merged converted structured data and the input structured data comprises of removal of conflicting merged data, classification of the merged data and de-duplication of the merged data.

The system of enrichment of data for digital product definition in a heterogeneous environment comprises a processor and a memory coupled to the processor configured to be capable of executing programmed instructions comprising and stored in the memory to convert, by the mining engine, an input unstructured data into structured data, assigning a priority, by the mining engine, to a combination of the converted structured data and merging it with an input structured data. The matching engine categorizes the merged converted structured data based on a predefined set of rules;

The profiling engine validates the merged converted structured data against the digital product definition the steps of converting categorizing and validating are iterated to achieve an optimized data for digital product definition.

### BRIEF DESCRIPTION OF DRAWINGS

The embodiments of this invention are illustrated by way of example and not limitation in the figures of the accompanying drawings, in which like references indicate similar elements and in which:

FIG. 1 is an exemplary embodiment of the method of enrichment of data for digital product definition in a heterogeneous environment.

FIG. 2 is block diagram of an embodiment of an exemplary computing system configured to facilitate the method described for enrichment of data for digital product definition in a heterogeneous environment

FIG. 3A, FIG. 3B and FIG. 3C describes an exemplifying scenario of using a lab report for digital data definition generation.

### DETAILED DESCRIPTION

Examples of this technology may be implemented in numerous ways, including as a system, a process, an apparatus, or as computer program instructions included on a computer readable medium such as a computer readable storage medium or a computer network wherein program instructions are sent over optical or electronic communication links.

A detailed description of one or more examples is provided below along with accompanying figures. The detailed description is provided in connection with such examples but is not limited to any particular embodiment. The scope is limited only by the claims and numerous alternatives, modifications, and equivalents are encompassed. Numerous specific details are set forth in the following description in order to provide a thorough understanding. These details are provided for the purpose of example and the described embodiments may be implemented according to the claims without some or all of these specific details. For the purpose of clarity, technical material that is known in the technical fields related to the embodiments has not been described in detail to avoid unnecessarily obscuring the description.

The embodiments described herein provide methods and systems for processing structured data and unstructured data. As will be explained in more detail below, in one embodiment, unstructured data and structured data are captured and correlated to define links between the structured data and any associated unstructured data. The unstructured data and the structured data are stored in one or more data structures. As a result, both structured data and unstructured data are integrated into a data repository where such data may be collectively accessed.

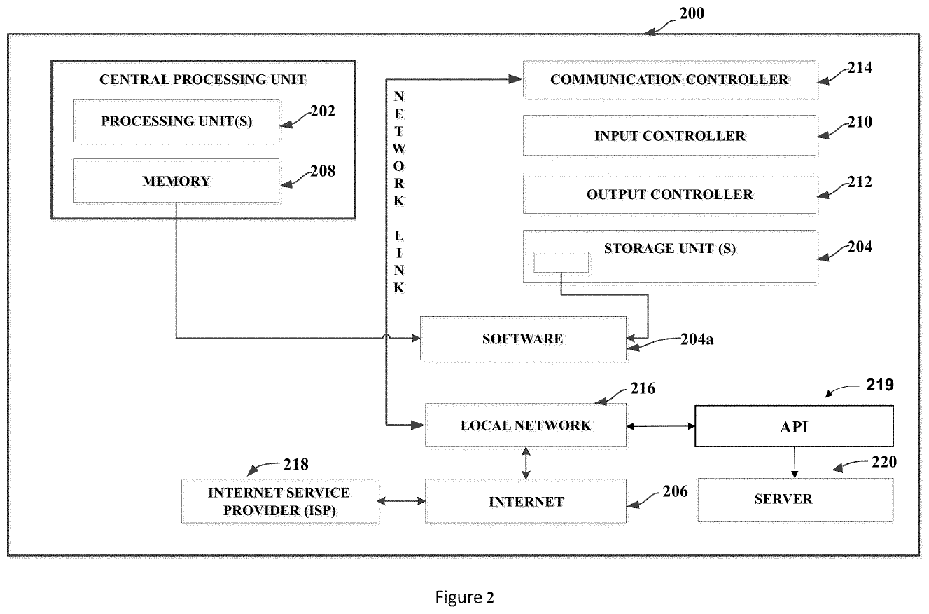

FIG. 2 is a block diagram of a computing device 200 to which the present disclosure may be applied according to an embodiment of the present disclosure. The system includes at least one processor 202, designed to process instructions, for example computer readable instructions (i.e., code) stored on a storage device 204. By processing instructions, processing device 202 may perform the steps and functions disclosed herein. Storage device 204 may be any type of storage device, for example, but not limited to an optical storage device, a magnetic storage device, a solid state storage device and a non-transitory storage device. The storage device 204 may contain software 204a which is a set of instructions (i.e. code). Alternatively, instructions may be stored in one or more remote storage devices, for example storage devices accessed over a network or the internet 206. The computing device also includes an operating system and microinstruction code. The various processes and functions described herein may either be part of the microinstruction code or part of the program (or combination thereof) which is executed via the operating system. Computing device 200 additionally may have memory 208, an input controller 210, and an output controller 212 and communication controller 214. A bus (not shown) may operatively couple components of computing device 200, including processor 202, memory 208, storage device 204, input controller 210, output controller 212, and any other devices (e.g., network controllers, sound controllers, etc.). Output controller 212 may be operatively coupled (e.g., via a wired or wireless connection) to a display device (e.g., a monitor, television, mobile device screen, touch-display, etc.) in such a fashion that output controller 212 can transform the display on display device (e.g., in response to modules executed). Input controller 210 may be operatively coupled (e.g., via a wired or wireless connection) to input device (e.g., mouse, keyboard, touch-pad, scroll-ball, touch-display, etc.) in such a fashion that input can be received from a user. The communication controller 214 is coupled to a bus (not shown) and provides a two-way coupling through a network link to the internet 206 that is connected to a local network 216 and operated by an internet service provider (hereinafter referred to as ‘ISP’) 218 which provides data communication services to the internet. Network link typically provides data communication through one or more networks to other data devices. For example, network link may provide a connection through local network 216 to a host computer, to data equipment operated by an ISP 118. A server 220 may transmit a requested code for an application through internet 206, ISP 218, local network 216 and communication controller 214. Of course, FIG. 2 illustrates computing device 200 with all components as separate devices for ease of identification only. Each of the components may be separate devices (e.g., a personal computer connected by wires to a monitor and mouse), may be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). Computing device 200 may be one or more servers, for example a farm of networked servers, a clustered server environment, or a cloud network of computing devices.

Data is the currency of the Digital Age. Establishing a single source of reference for integrated digital product across the organization's portfolio provides a broader technical visibility and enables smarter product management. The Digital or non-digital R&D product definitions are spread in multiple IT application and follow different definitions and processes. The data are available in both structured and unstructured form. The unstructured data and mix of unconnected data poses challenges to form integrated digital data. The data quality completeness of migrated specification data for all Materials, Formulas, and Finished Goods from various disparate data sources to Global Spec Management system across the globe is essential for faster digital operations.

The Digital data definition of R&D specification structure may include, but not limited to, Pallet unit, Traded unit, Consumer unit, Formulation, Packaging Material, Printed Packaging Material, and Ingredients. The digital data refers to the product specification as connected, modelled and consistent data stored in computer system that can be searched or exchanged by user or another system and refer or use in the same context.

The Invention describes a mapping of external data comprising of structured and unstructured data that helps to ingest data into a data staging area for controlled consumption. This data is composed to form the skeleton digital data model. The data mapping allows to compose set of objects which are interlinked forms the bill of material. The composed data consist of structured and unstructured data but it gets enriched and evolves through multiple iterations into mature integrated and structured digital data. The iterations lead to the population of data through data mining and data matching. The outcome of the data preparation is subjected to data optimization such as cleansing, data enrichment, data classification, data de-duplication etc. The structured and unstructured data has conflicts, inconsistency and may be incorrect. The digital data acceleration method provides the collaborative and iterative methods to generate the matured integrated digital data

The Digital Data Acceleration Method is devised keeping in mind, the need of iterative data preparation and iterative data optimization. When there are multiple external data present in different format and are also different in context, having a consistent digitally well-connected data system is a challenge. In order to overcome this gradually and systematically connecting the data with adequate verification is needed to qualify the integrated digital data. The well-defined operations over the data with traceability is needed to qualify the final data for operational use.

The Digital Data Acceleration Method is unique by deploying the powerful engine which supports to mine the unstructured data and merge with the Structured base data. In addition to this, it is configured to align the structured data with the deferred matching results which occurs due to the ambiguity in selecting the right data when data conflict occurs. The extension of machine learning out of user's consistent data preference leads to recommendations. The transformation of structural data converts the data which is consistent across the digital data model but provides adequate spaces for data cleansing, data enrichment, data classification, structuring and data de-duplication.

A combination of data mining, matching, and profiling is used to prepare the data with essential data quality indicators. Data mining (A1) is aimed to extract data from unstructured data (102b) and add to it the base data. A deferred matching process is adopted to project the data for final selection. Matching and Profiling are the mechanisms that qualify the prepared data and provide the quality deviations from the target digital data quality.

The method of iterative data optimization includes the review of matching and profiling results and take adequate actions to improve the data. Data cleansing, data enrichment and data remediation ensures the data corrections for its completeness and correctness. On the other hand, structuring, classification and de-duplications are data manipulation activities at the record level in order to develop new classification and elimination of redundant data through contextual matching.

The data preparation and data optimization steps are iterative operations will be repeated until the data quality reaches the desired maturity and is consistent with the target data definition.

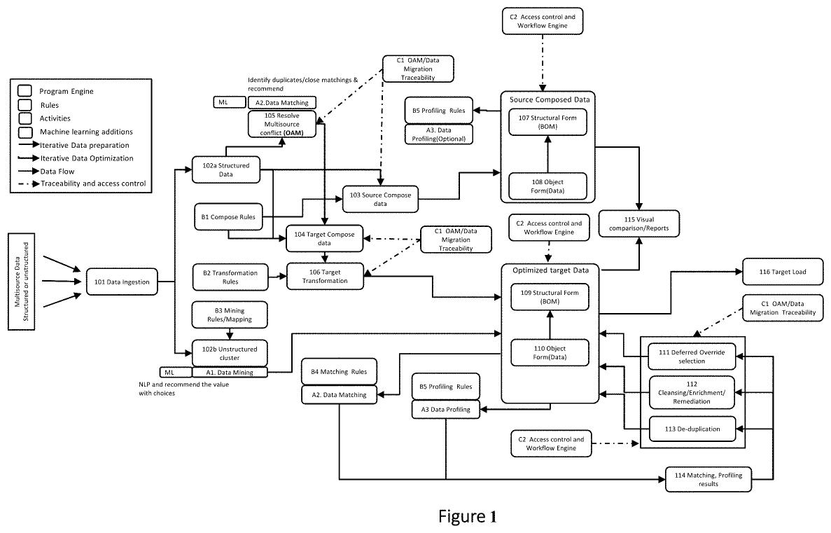

FIG. 1 is an exemplary embodiment of the method of enrichment of data for digital product definition in a heterogeneous environment. Data from different sources and in various forms viz structured and unstructured data, is passed through Data ingestion interface (101). The data ingestion interface may include a GUI for input of data. Other embodiments of the data ingestion interface may include an automated data input means which is configured to capture data from various pre-configured sources. The data ingestion interface may be further configured to automatically establish a connection with the various pre-established sources using a login functionality in order to ensure verified data sources may only be used to fetch the data to be captured through the Data Ingestion Interface. The external data from multiple sources is received through a secured channel and maintained for further processing. The data ingestion interface identifies the changed record during each input ingestion and update/insert only the latest data, thereby reducing the error due to duplication of data received. Data ingestion interface also identifies the latest record captured and adds a “Latest” label to it and sets the process flag as “Not-Processed”. The ingestion interface is also configured to assign other process flags and the process flags may be selected amongst one of the below:

“Not Processed”: The record is updated for new changes or the record is created fresh, the compose function is yet to pick up the record.
“Processing”: The composition rules are executed against the records for field by field mapping. Field to field mapping refers to defining which source field is to be processed and transferred to another compose field
“Processed”: The record processing is completed by compose function. Details of the processing are discussed in detail henceforth in the description.

The Ingestion interface (101) divides the data in two sets based on the type of data captured and is configured to store the data in disjoint storage locations for both structured data (102a) and unstructured data (102b). The unstructured data are maintained under file folder and the path to the file folder is maintained in a database table.

The compose function, executed by the processor (202), fetches only the records with “Not-processed” and/or “processing” flags from the ingested data stored in database tables and then run the composition logic on them. All the compose rules (B1) are configured separately for each source system as per mapping and stored in a compose rules database table. These rules may be extended to other implementation scenarios with minimal configuration changes.

Any new mapping or change in mapping logic may require that addition of a new composition rule in compose rule database table. There are two types of compose data called Source compose data (103) and the target compose data (104). When the compose program is executed and the ingested data is processed the system marks the ingested data with the flag as “Processed”.

All source compose data (103) and target compose data (104) will have a field “Is Modified” which contains one of the flags among New, Modified and Processed. The New flag is for newly generated compose records. The Modified flag is applied when there is a record that is not processed in extraction table. The Processed flag is applied after the data is moved to next stage to mark compose action as final for the record.

In one embodiment, the composition of data involves processing the target compose data (104) based on the predefined compose rules and assigning a data priority. The data priority obtained based on the compose rules results in overriding source data by another source data (102a) through an Override-Automate-Manual (OAM) technique (105). OAM technique is used to capture any kind of change done to the data during the end-to-end data consolidation process and maintains the history of data change. The mechanism of the OAM technique is based on the three modes of operation on the source data namely override, automate and manual update. In the override mode of operation, when multiple data sources are considered, the system is instructed to consider the predefined overriding rules i.e. high priority data source will be considered against the low priority data source when multiple data sources are identified for same data. The overridden data is available for deferred data selection during data optimization. Additionally, but not limited to, the user can still have an opportunity to select data from less preferred data source.

In another embodiment the Automated mode of operation is used when the composed data is to be transformed. Target Transformation function (106) moves the data from original data to new or modified data as per the transformation rule (B2). The data transformation actions are captured in order to maintain a traceability of the data changes and such history may be used for traversing the changes in digital data definition.

In another embodiment Manual mode of composition of data is used when the user decides and perform any action during cleansing, enriching, classification, remediation, and structuring. Such transformation of data is captured in order to maintain a traceability of the data changes and such history may be used for traversing the changes in digital data definition

In one more embodiment, the overridden data is captured and replayed during the iterative data optimization cycle which involves selection of overridden data in a deferred mode (111). The Overridden data along with priority is captured in the OAM technique and Data migration traceability functions (C1). The source compose data is used to create the source data records in the Structural Form (BOM) (107) and Object form (108) in order to compare the source composed data against the optimized target data in Structural form (BOM) (109) object data form (110). The target compose data undergoes target transformation and resulting in to optimized target data at the initial stage (109, 110). Predefined and transformation rules are used to transform the composed data which fits for a target application. The target transformation is based on the target transformation function (106) which copies/inserts records from target compose data which have “is_modified” flag set as “New” or “Modified”. The transformation function performs the transformation again for the newly updated/inserted row separately. The other data records which do not have the “is modified” flag set to “New” or “modified” are not affected during this process.

In one embodiment, upon completion of the transformation the records field “is_modified” flag is updated as “Processed” in target compose (104) and in Optimized target data.

In another embodiment, data in source and target forms are captured under OAM and Data migration traceability functions (C1) as part of transformation function (106). The lifecycle status flag of the optimized target data record is set to “draft” and the data is considered to be ready for iterative data preparation and iterative data optimization cycle. The Digital data from structured data source is organized to start the data preparation operation. Following operations of data mining (A1), data matching (A2) and data profiling (A3), are performed in the process of preparation of the digital data and validate and highlight for data optimization.

In one embodiment data mining deals comprises the extraction and identification of hidden data from unstructured data which is not considered useful for digital use in the process of digital data definition creation. The unstructured data cluster (102b) is isolated for data mining during the ingestion (101). The Optical character recognition (OCR) process performed through an OCR program and the natural language combined with supervised Machine learning technique support data mining (A1) the data for the defined set of attributes that helps to build the records. In the process of data mining (A1) the data is extracted and assessed for the record where the data is appropriate and may support the digital model definition. In one more embodiment, data mining may be performed in two ways, Header attribute mining and Table Mining. The Header attribute mining helps to mine the data from the unstructured data for defined attributes. The data hidden in any paragraph or any form of attribute name or its defined set of token names present in the file. Header Attribute Mining is done at the attribute level and further filtered using machine learning. Since similar pattern is noticed in different unstructured documents are identified using CNN or RNN AI algorithms. Table Mining is performed by locating the tables (rows and columns) with data and extracting to align with latest transformed records (110).

In one embodiment, as part of the data preparation, the identified data from successful mining is presented for selection of the data to support data enrichment or filling missing data in the structured records (110). Newly added data from Mining (A1) is to be subsequently validated for its completeness and correctness by the Profiling rules (B5) and Matching rules (B4) through Data profiling and data matching engines (A3, A2)

In another embodiment, data matching is performed by grouping or classifying the target data (109,110) to further cleanse or enrich the data. In the process of matching, the conflicting data is reasoned and either cleansed, or enriched, or marked as redundant data and de-duplicated.

Any record in a digital model is defined by set of attributes. The records are merely data that is received from various heterogeneous sources. The data matching process helps to identify and finalize unique records when multiple data is present from various sources.

In one embodiment, attribute matching of the data from source is done either override one data over the other based on the pre-defined override rules or present to the user as a choice to select during the data optimization process. i.e. source X data is preferred over source Y data if X data is available. Matching also provides the facility to verify the similarity or pattern across group of data and allows the user to cleanse or enrich to improve the data classification maturity e.g. When certain characteristics of the data is consistent for group of records then classify them for data analysis. Data classification maturity may be considered to be high when more records meet the criteria for grouping. A low maturity of data classification exists if the records do not match a grouping criterion.

In another embodiment, a structure matching is performed at the parent child relationship of the records. Structure matching may also me termed as Bill of Material Matching and is performed when different types are records are interconnected. The structure modification is part of data optimization process. The source structure is compared with modified structure to iteratively review if the data is consistent.

In one embodiment, matching rules (B4) are built to perform the data matching operations that elevates the data behavior as group. The matching rules are built as conditions for combining multiple records or data. When the condition fails the matching engine highlights the failures. The matching generally is performed when the target data is matured through data mining (A1) and/or data optimization operations (111, 112, 113 and 114) performed in order to consider the latest data.

In one embodiment, Data Profiling (A3) is performed in order to qualify the data for its consistency and the accuracy based on the profiling rules (B5) defined for the target digital data model. There are several profiling or data validations performed across the composed or optimized data after adequate data mining (A1) and data matching (A2). Three types of profiling are performed on the unstructured data and is configured in the system to be automated for an iterative data optimization.

In on embodiment, horizontal profiling is performed to qualify one or more attribute values or group of attributes within the record based on the predefined rules which is part of Data profiling (A3).

In another embodiment, vertical profiling in performed to group relevant records and qualify as a group that is consistent. Vertical profiling is also used develop the group of similar records. The de-duplication of records to prevent redundant data which is part of data matching (A2) is also performed as part of vertical profiling.

In yet another embodiment, multiple parent-child hierarchy is connected through the process of structural profiling and the result is processed to qualify the structure of different type of records which is part of data profiling (A3)

In one embodiment all the three operations of data mining (A1), data matching (A2) and data profiling (A3) are to be executed in an order to benefit the best outcome. The outcome of data preparation is stored as matching and profiling results (114). The results consists of “Fail”s and “Pass”s. The “Fail”s indicate, it requires cleansing or enrichment to improve its quality and further mature the integrated digital model. Data optimization operations are performed on the basis of the matching results (114). It may be noted that the data optimization operations may be applied in a controlled manner in any order depending on the qualification results coming out of data mining (A1), data matching (A2) and data profiling (A3), and should not be limited to the order described herein as an exemplifying embodiment.

In one embodiment data de-duplication (113) is performed when multiple records of same kind or characters are identified based on defined attributes of the record conditions and can indicate that the duplicate exist. A power user may be prompted through a user interface to decide and de-duplicate to optimize the integrated digital data model. The user may select the appropriate record and discard the one that may not be relevant to the target digital data.

In another embodiment, data remediation (112) when the data inaccuracies are highlighted with configured profiling results, a user can take the decision to fix the data issues and improve the data quality, Data Cleansing (112) when the data inconstancy identified by various profiling failed rule through the profiling Engine (A3), one can cleanse the data and improve the digital data quality which are essential for data analytics, Data enrichment (112) when the missing data or incomplete data highlighted with configured profiling results, a user can further add the missing data and improve the comprehensiveness of the data. The Visual comparison or data or reports (115) helps to review the net changes from initial source compose data until matured optimized target data.

In one embodiment the access control and workflow engine (C2) is configured to perform data preparation and data optimization operations in a controlled manner. The workflow engine allows various participants to collaboratively work on the data, review and provide approval. When the user who has access to approve the matured data model can approve and mark it as fully qualified digital data model for target IT application. The target load function (116) is used to export the digital data model as xml output or excel output for subsequent use. The digital data that is produced is used in the digital data model to perform the intended enterprise operations.

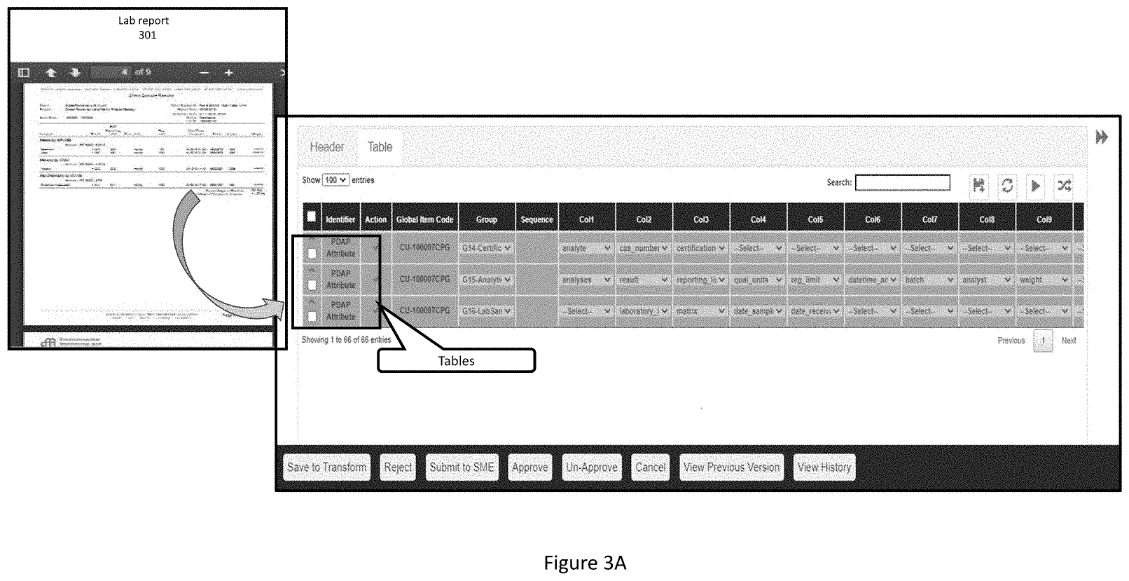

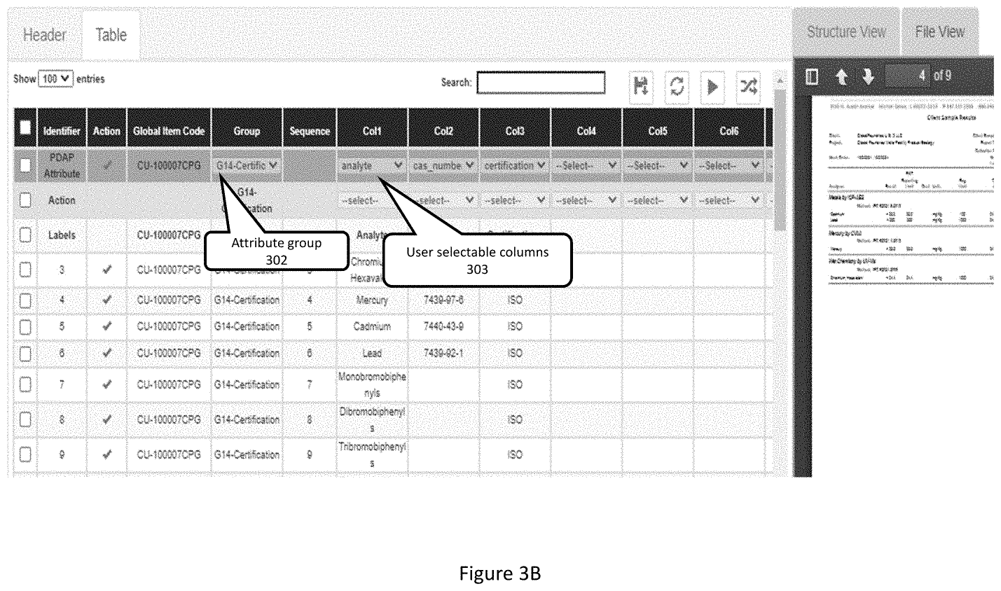

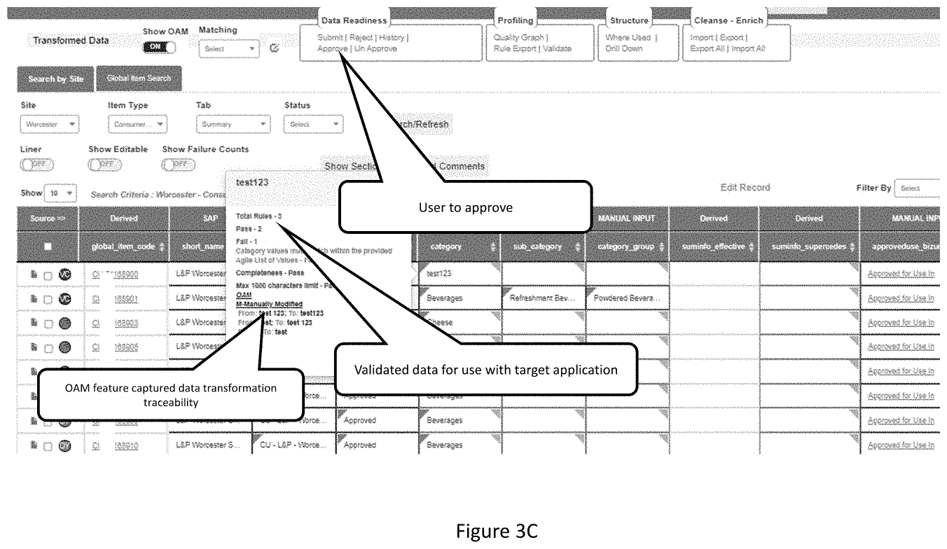

In an exemplifying embodiment, depicted through FIG. 3A, FIG. 3B and FIG. 3C a scenario of using a lab report (301) for digital data definition generation is being described. The lab report obtained from a supplier may have data arranged under multiple headings and in disparate columns and rows. The table columns, order of the columns and the column name are also different for each supplier. Such data may be termed as unstructured data. The data ingestion module performs the extraction from PDF file using the OCR program. This data may refer to different tables during data ingestion. The mining engine converts the input unstructured data into structured data and then assigns a priority to a combination of the converted structured data and merges it with any input structured data that may be mined from the lab report. The matching engine performs a categorization of the merged converted structured data based on a predefined set of rules and the validation of the records thus obtained is performed by the profiling engine against the digital product definition or attributes/attribute groups (302). The user may need to verify from the user selectable columns (303) if the converted data can be automatically mapped with target digital definition and identified with the appropriate columns. Multiple functions such as merge tables, map to new columns, swap columns between tables, drop columns, drop rows etc. are performed in order to qualify the input data as usable for digital product definition. The outcome from the data re-structuring may be stored as a formal data as transformed data. The stored data may be further validated for all the business rules in order to make it compatible for use with the target application.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry, firmware, software or any combination of hardware, firmware, and software (e.g., embodied in a machine readable medium).

In addition, it will be appreciated that the various operations, processes, and methods disclosed herein may be embodied in a machine-readable medium and/or a machine accessible medium compatible with a data processing system (e.g., a computer devices), and may be performed in any order (e.g., including using means for achieving the various operations). The medium may be, for example, a memory, a transportable medium such as a CD, a DVD, or a portable memory device. A computer program embodying the aspects of the exemplary embodiments may be loaded onto the retail portal. The computer program is not limited to specific embodiments discussed above, and may, for example, be implemented in an operating system, an application program, a foreground or background process, a driver, a network stack or any combination thereof. The computer program may be executed on a single computer processor or multiple computer processors.

Moreover, as disclosed herein, the term “computer-readable medium” includes, but is not limited to portable or fixed storage devices, optical storage devices and various other mediums capable of storing or containing data.

Accordingly, the specification and drawings are to be regarded in an illustrative rather than a restrictive sense.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for enriching data for digital product definition in a heterogeneous environment, the method comprising:
converting, through a mining engine, an input unstructured data into structured data,
assigning a priority, by the mining engine, to a combination of the converted structured data and merging it with an input structured data;
categorizing, by the matching engine, the merged converted structured data based on a predefined set of rules;
validating, by a profiling engine, the merged converted structured data against the digital product definition; and
iterating the steps of converting through validating, to achieve an optimized data for digital product definition.

2. The method of claim 1, wherein the structured data and the unstructured data are received through a user interface and an automated data ingestion module.

3. The method of claim 1, wherein the priority is assigned based on predefined target data structure attributes, contextual attribute tokenization and the machine learning dependent attribute value selection.

4. The method of claim 1 wherein the categorization of the merged converted structured data and the input structured data comprises of removal of conflicting merged data, classification of the merged data and de-duplication of the merged data.

5. The system of enrichment of data for digital product definition in a heterogeneous environment, the system comprising:
a processor; and
a memory coupled to the processor configured to be capable of executing programmed instructions comprising and stored in the memory to;
convert, by the mining engine, an input unstructured data into structured data,
assigning a priority, by the mining engine, to a combination of the converted structured data and merging it with an input structured data;
categorizing, by the matching engine, the merged converted structured data based on a predefined set of rules;
validating, by a profiling engine, the merged converted structured data against the digital product definition; and
iterating the steps of converting through validating, to achieve an optimized data for digital product definition.

6. The system of claim 5, wherein the structured data and the unstructured data are received through a user interface and an automated data ingestion module.

7. The system of claim 5, wherein the priority is assigned based on predefined target data structure attributes, contextual attribute tokenization and the machine learning dependent attribute value selection.

8. The system of claim 5, wherein the categorization of the merged converted structured data and the input structured data comprises of removal of conflicting merged data, classification of the merged data and de-duplication of the merged data.

9. A non-transitory computer-readable medium having computer-readable instructions stored thereon that are executable by a processor to:
convert an input unstructured data into structured data,
assigning a priority to a combination of the converted structured data and merging it with an input structured data;
categorize the merged converted structured data based on a predefined set of rules;
validate the merged converted structured data against the digital product definition; and
iterate the steps of converting through validating, to achieve an optimized data for digital product definition.
